(19) United States
(12) Patent Application Publication
(10) Pub. No.: US 2026/0240143 A1
(43) Pub. Date: Aug. 20, 2026

(54) Repellent Device

(71) Applicant: Woodstream Corporation, Lancaster, PA (US)

(72) Inventors: Kierstin Bersheim, Lancaster, PA (US); Matthew Kauffman, Manheim, PA (US); Marko Lubic, Shillington, PA (US); Michael Adamson, Elizabethtown, PA (US); Andrew Gauker, Mohnton, PA (US); Shane Nagle, Lititz, PA (US); Chad Spangler, Hummelstown, PA (US)

(73) Assignee: Woodstream Corporation, Lancaster, PA (US)

(21) Appl. No.: 19/058,318

(22) Filed: Feb. 20, 2025

(51) Int. Cl. A01M 29/12; A01M 7/00

(52) U.S. Cl. CPC A01M 29/12; A01M 7/0017; A01M 2200/012

(57) ABSTRACT

A repellent device includes a housing having a port and a cartridge having a shape corresponding to the port. The cartridge contains a repellent material. The cartridge is removably insertable into the housing and has a front cartridge wall visible at the port from an exterior of the repellent device when the cartridge is disposed in the housing.

### FIELD OF THE INVENTION

The present invention relates to a repellent device and, more particularly, to a repellent device for repelling mosquitos and other insects.

### BACKGROUND

Repellent devices typically accept cartridges filled with a repellent, which is volatized to repel pests such as mosquitos. Repellent devices may also use repellent pads in lieu of cartridges. The cartridges or pads are contained in a housing and commonly require the housing to be at least partially disassembled in order to refill or replace the cartridge or pad, or to determine a level of repellent left in the cartridge. Additionally, existing repellent devices disperse the repellent over a small area while creating condensation in the housing, reducing the effectiveness of the repellent and reducing the useful life of electronic components of the repellent device.

### SUMMARY

A repellent device includes a housing having a port and a cartridge having a shape corresponding to the port. The cartridge contains a repellent material. The cartridge is removably insertable into the housing and has a front cartridge wall visible at the port from an exterior of the repellent device when the cartridge is disposed in the housing.

### BRIEF DESCRIPTION OF THE DRAWINGS

The invention will now be described by way of example with reference to the accompanying figures, of which:

FIG. 1 is a front view of a repellent device according to an exemplary embodiment;

FIG. 2 is a rear perspective view of the repellent device of FIG. 1;

FIG. 3 is an exploded perspective view of the repellent device of FIG. 1;

FIG. 4 is a sectional view of the repellent device of FIG. 1 taken along line A-A;

FIG. 5 is a partial exploded perspective view of the repellent device of FIG. 1, with a cartridge separated from the repellent device;

FIG. 6 is an exploded view of the cartridge of FIG. 5.

FIG. 7 is a perspective view of a bottom shell, a shell band, and a slide assembly of the repellent device of FIG. 1;

FIG. 8 is the perspective view of FIG. 7 further showing the cartridge of FIG. 5 removably inserted into a port of the bottom shell of FIG. 7;

FIG. 9 is the perspective view of FIG. 8 further showing a PCB and volatilization elements of the repellent device of FIG. 1;

FIG. 10 is the perspective view of FIG. 9 further showing a power source and a fan having a fan housing of the repellent device of FIG. 1;

FIG. 11 is a perspective view of the PCB of FIG. 8; and

FIG. 12 is an exploded view of a PCB assembly.

### DETAILED DESCRIPTION OF THE EMBODIMENT(S)

Exemplary embodiments of the present invention will be described hereinafter in detail with reference to the attached drawings, wherein like reference numerals refer to like elements. The present invention may, however, be embodied in many different forms and should not be construed as being limited to the embodiments set forth herein; rather, these embodiments are provided so that the present disclosure will convey the concept of the invention to those skilled in the art. Moreover, the embodiments and features thereof are only possible configurations in which, however, the individual features as described herein can be provided independently of one another or can be omitted.

Throughout the drawings, only one, multiple, or all of a plurality of identical elements may be labeled in a figure for clarity of the drawings, but the detailed description of the element herein applies equally to each of the identically appearing elements in the figure if all elements are not labeled.

A coordinate system is provided in some of the figures for ease of understanding a repellent device 1 and should not be construed as limiting the repellent device 1 or elements thereof to any particular orientation. The coordinate system comprises a vertical direction Y, a horizontal direction X perpendicular to the vertical direction Y, and a transverse direction Z. The transverse direction Z is perpendicular to the vertical direction Y and the horizontal direction X. A relative length, width, or thickness of the elements appears throughout the figures; however, the relative length, width, or thickness of the elements are merely illustrative and are not meant to be representative of a particular length, width, or thickness of any of the elements unless stated otherwise herein.

Throughout the specification, various terms are used to describe the repellent device 1. The terms “removably insertable”, and “removably attachable”, or any iteration thereto, is intended to mean that an element is insertable or attachable to another element such that a secure connection between the elements is made, but the connection can easily be undone without the need to take apart a housing and/or the use of tools such as hammers, Allen keys, screwdrivers, drills, etc.

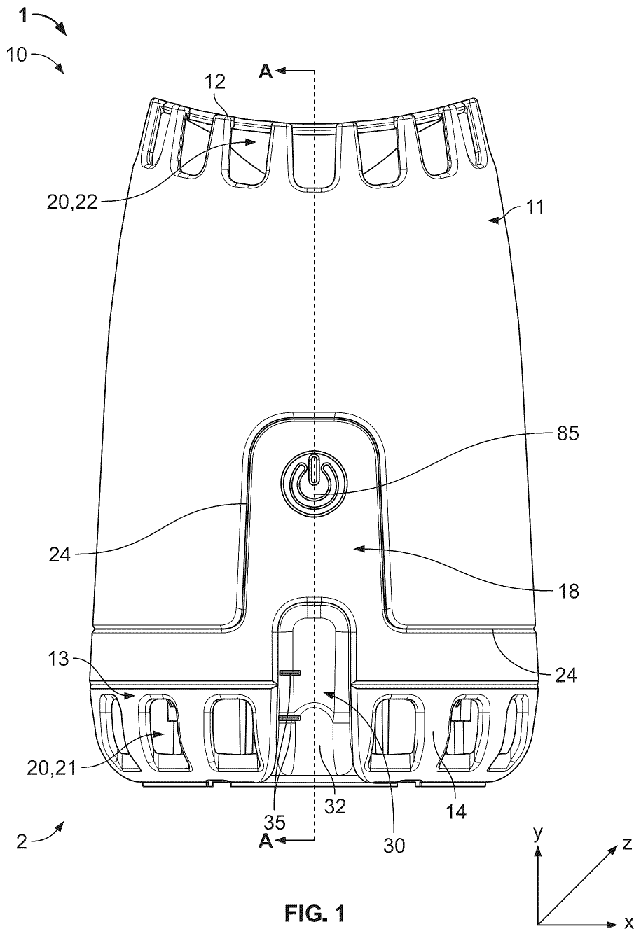

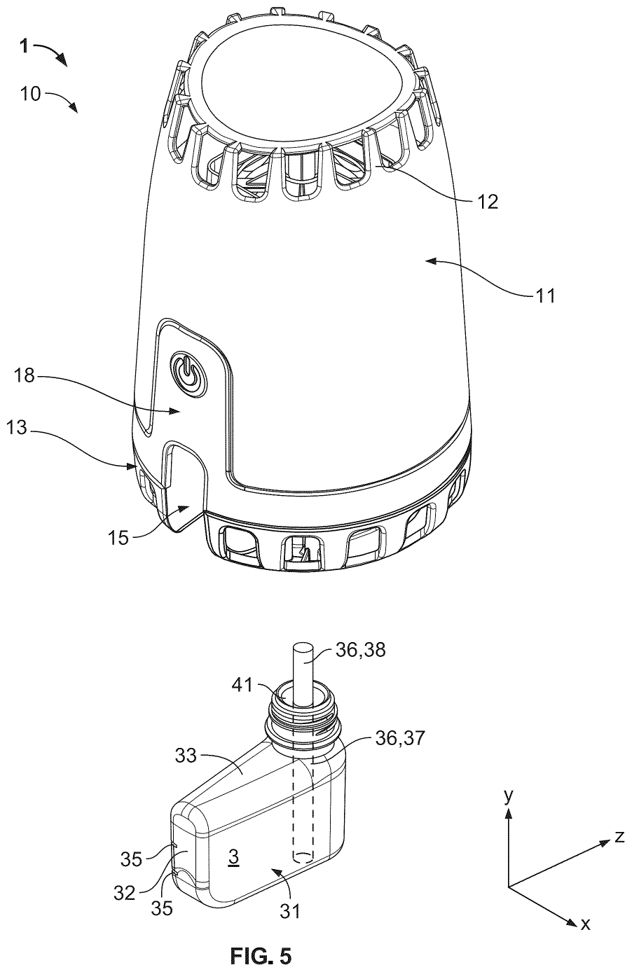

The repellent device 1 according to an exemplary embodiment is now described with reference to FIGS. 1-12. The repellent device 1 contains and disperses a repellent mixture 3, shown in FIG. 5. The repellent mixture 3 of the present embodiment is an insecticide fluid. In an exemplary embodiment, the repellent mixture 3 is transfluthrin. In various other embodiments, the repellent mixture 3 may be anything that repels mosquitoes, insects, or other pests that can be volatilized.

The repellent device 1 includes a housing 10 that receives a cartridge 30 containing the repellent mixture 3. In the embodiment shown in FIGS. 1-2 and 4-5, the housing 10 comprises a top shell 11, a bottom shell 13 opposite the top shell 11 in the vertical direction Y, and a shell band 18 connecting the top shell 11 to the bottom shell 13.

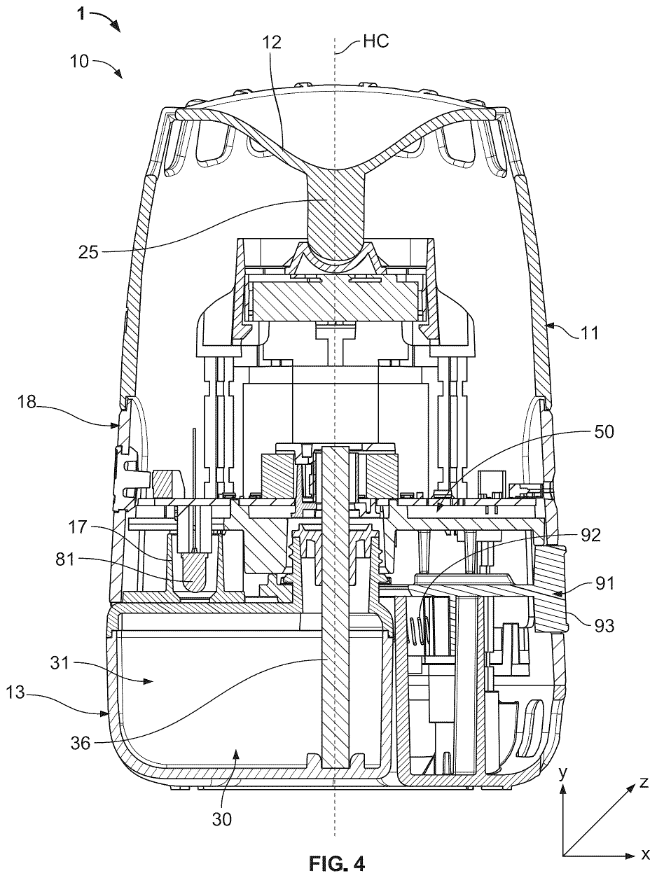

As shown in FIGS. 1 and 4-5, the top shell 11 is an approximately cylindrical member that has a top part 12, which forms a top surface of the top shell 11, and a fan retaining portion 25 connected to the top part 12 and protruding into an interior of the top shell 11. The fan retaining portion 25 is shown centrally on the top part 12 of the top shell 11 in FIG. 4. In various other embodiments, the fan retaining portion 25 may be in any part of the top shell 11.

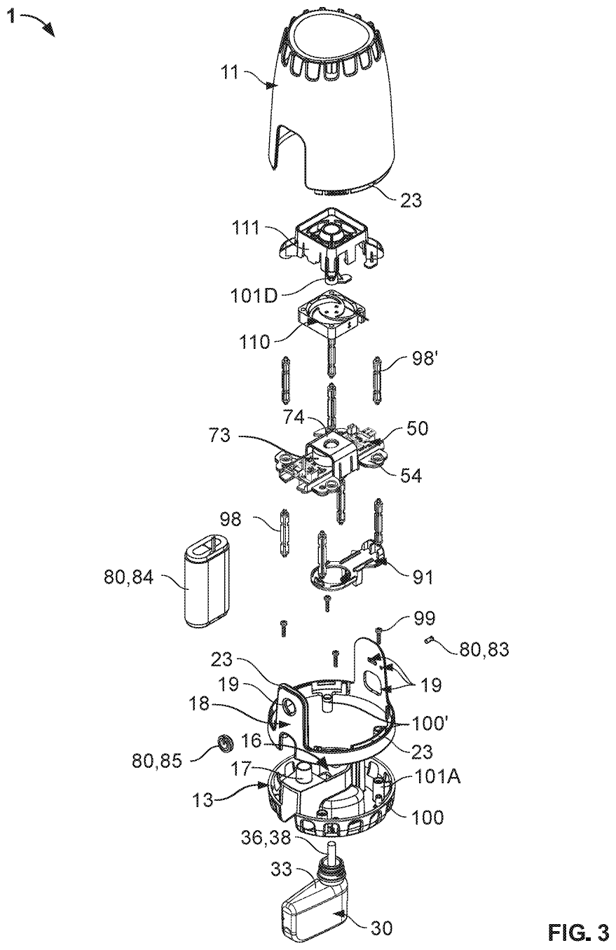

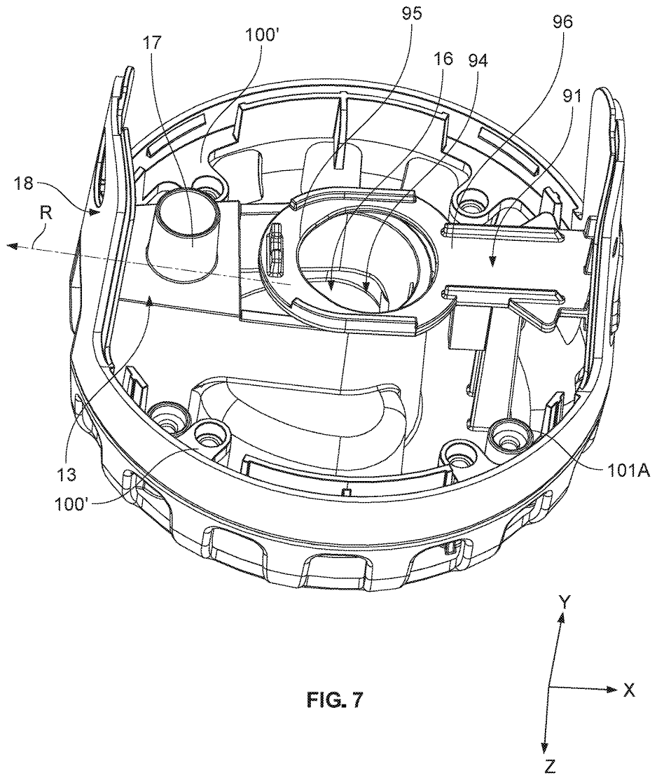

The bottom shell 13, as shown in FIGS. 1, 3-5, and 7, is an approximately circular member that has a bottom shell wall 14, a port 15 in the bottom shell wall 14, and a port passageway 16 extending from the port 15 into the bottom shell 13. The port 15, as shown in FIG. 5, has a shape corresponding to a face of the cartridge 30. The port passageway 16, shown in FIGS. 3 and 7, has a shape corresponding to the cartridge 30 and receives the cartridge 30. As shown in FIGS. 3, 4, and 7, the bottom shell 13 has a lighting guide 17 positioned above the port 15 and the port passageway 16. The lighting guide 17 extends away from the port passageway 16 in the vertical direction Y. The lighting guide 17 has a shape corresponding to a shape of a lighting element 81 and a passageway for receiving the lighting element 81 that communicates with the port passageway 16. In various other embodiments, the port 15 and/or the lighting guide 17 may not be part of the bottom shell 13 and instead are in another part of the housing 10.

The housing 10 comprises a plurality of vents 20 shown in FIG. 1, which include a first set of vents 21 and a second set of vents 22.

As shown in FIG. 1, the first set of vents 21 are formed into the bottom shell wall 14. Each vent of the first set of vents 21 extends through the bottom shell wall 14 into an interior cavity of the bottom shell 13, communicating between an area within the bottom shell 13 and an exterior environment (e.g., the surroundings of the repellent device 1). In various other embodiments, the bottom shell 13 may have any number of vents or sets of vents anywhere on the bottom shell 13 that allows the communication described herein.

As shown in FIG. 1, the second set of vents 22 are formed in the top part 12. Each vent of the second set of vents 22 extends through the top part 12 into an interior cavity of the top shell 11, thereby placing the interior cavity in communication with the exterior environment. The top shell 11 may have any number of vents 22 or sets of vents anywhere on the top shell 11 that allow the interior cavity of the top shell 11 to communicate with the exterior environment.

The shell band 18, as shown in FIG. 3, is an approximately circular element with a pair of interconnection portions 23 extending in the vertical direction Y. The shell band 18 has a plurality of shell band passageways 19 extending through the shell band 18. In another embodiment, the plurality of vents 20 have another set of vents formed into the shell band 18.

The top shell 11, the bottom shell 13, and the shell band 18 of the housing 10 are formed of a thermoplastic polymer material. In an exemplary embodiment, the thermoplastic polymer material is an acrylonitrile butadiene styrene (“ABS”). In various other embodiments, the housing 10, and the components thereof, may be formed of any material that allows the housing 10 to contain the components described herein and perform the repellent function in an outdoor environment. In the shown embodiment, the top shell 11, the bottom shell 13, and the shell band 18 are each monolithically formed in a single piece. In various other embodiments, the housing 10 may be monolithically formed in a single piece, formed of any other number of component parts, or formed in any way that allows the housing 10 to function as described herein.

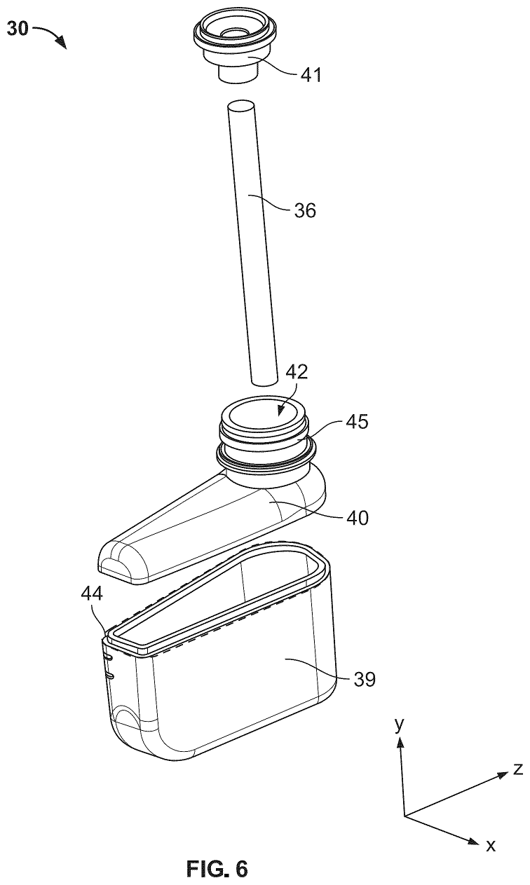

As shown in FIGS. 1-6, the repellent device 1 also includes the cartridge 30 that is removably positionable in the housing 10. The cartridge 30 defines a cartridge interior 31 that contains the repellent mixture 3. As shown in the embodiment of FIG. 6, the cartridge 30 has a cartridge passageway 42 extending into the cartridge interior 31 and a cross-sectional shape 44. In the present embodiment, the cross-sectional shape 44 is an asymmetrical shape. In various other embodiments, the cartridge 30 may have any shape 44 that allows the cartridge 30 to contain the repellent mixture 3 and mate with the port 15 as described herein.

The cartridge 30 includes a front cartridge wall 32 and a top cartridge wall 33 approximately perpendicular to the front cartridge wall 32, as shown in FIG. 5, that in part define the cartridge interior 31. In the present embodiment, the front cartridge wall 32 and/or the top cartridge wall 33 are transparent or translucent. In another embodiment, the cartridge 30 can be entirely transparent or translucent. In an embodiment, the cartridge 30 is formed of a polymer material. The polymer material in the present embodiment is a polymer material compatible with petroleum distillates.

As shown in FIGS. 1 and 5, the cartridge 30 has a plurality of graduations marks 35, which are marks formed in the front cartridge wall 32 for indicating a level of repellent mixture 3 contained in the cartridge interior 31. Each graduation mark 35 is spaced apart from one another in the vertical direction Y. In another embodiment, the plurality of graduation marks 35 are not formed in the front cartridge wall 32 and are instead a separate element attached on a surface of the front cartridge wall 32. In various other embodiments, the plurality of graduation marks 35 may be at least one graduation mark 35 or include any number of graduation marks 35 on any of the plurality of cartridge walls.

In an embodiment shown in FIG. 6, the cartridge 30 is formed of a first cartridge part 39 and a second cartridge part 40. The first cartridge part 39 and the second cartridge part 40 of the present embodiment are formed by injection molding. In various other embodiments, the first cartridge part 39 and the second cartridge part 40 may be formed by any method. In another embodiment, the cartridge 30 may not have the first cartridge part 30 and the second cartridge part 40 and instead may be monolithically formed.

The cartridge 30 has a wick 36 that, as shown in FIG. 5, has a first wick portion 37 and a second wick portion 38 extending from the first wick portion 37 in the vertical direction Y. the wick 36 may be formed of any type of material used for wicking insect repellents.

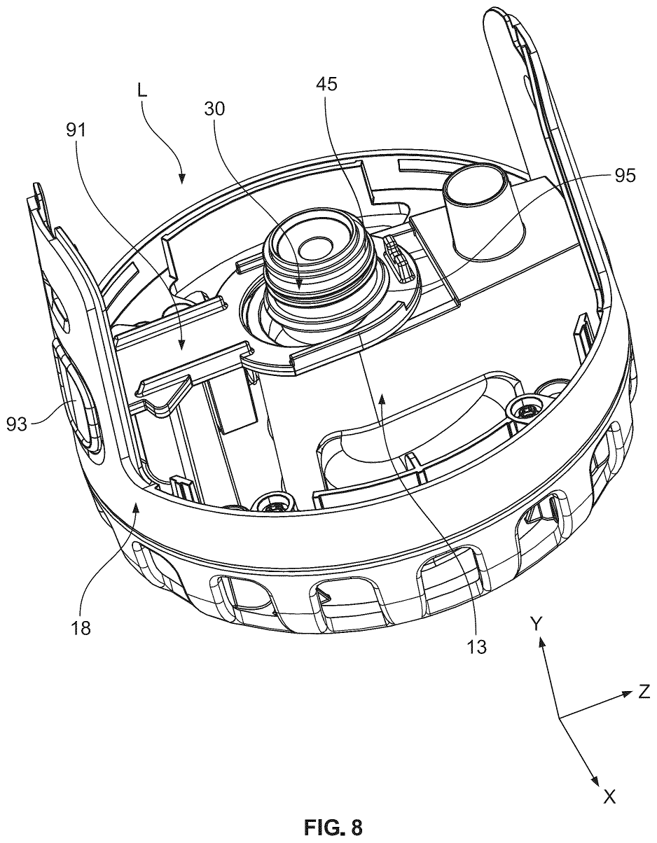

The cartridge 30, as shown in FIGS. 6 and 8, has a neck portion 45 with an external thread. The external thread is complementary to an internal thread of a cap that threads onto the cartridge 30 to prevents the wick 36 from being completely exposed to the exterior environment. In another embodiment, the cap may be attached onto the cartridge 30 in any way, such as a snap-fit, press-fit, etc., that allows the cap to prevent the wick 36 from being completely exposed to the exterior environment.

The cartridge 30 has a bushing 41, as shown in FIGS. 5-6. The bushing 41 can be inserted into the cartridge passageway 42 and has a bushing passageway that extends through the bushing 41.

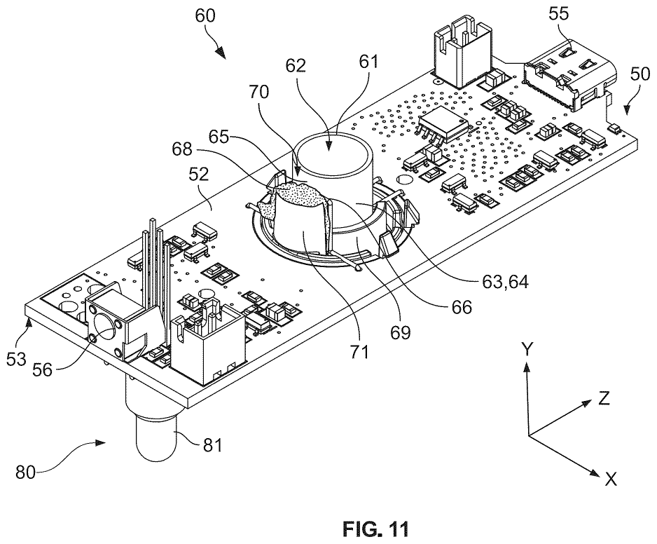

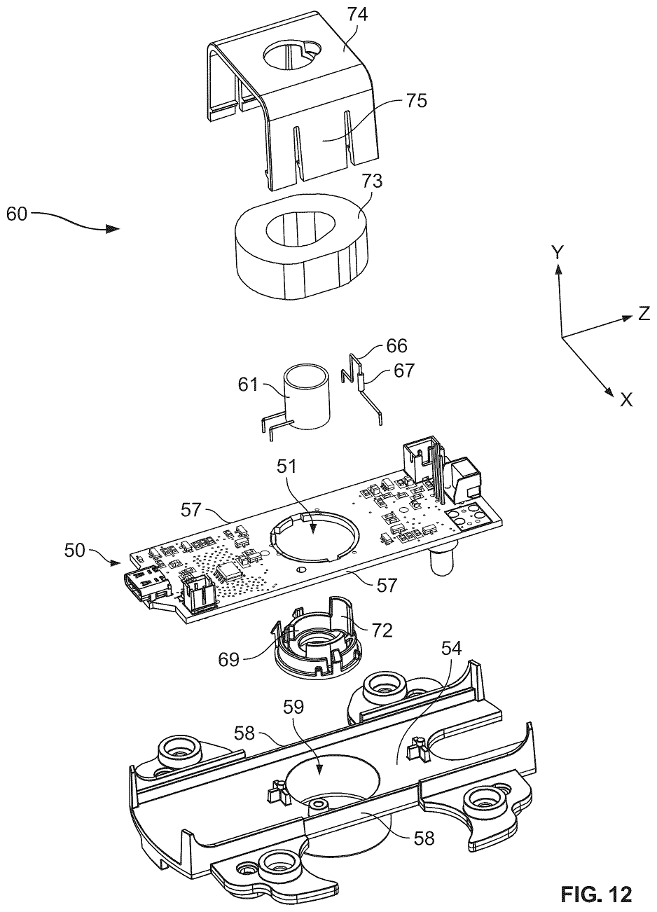

As shown in FIGS. 3-4 and 9-10, the repellent device 1 includes a PCB 50 inside the housing 10. The PCB 50, as shown in FIGS. 11 and 12, comprises a PCB passageway 51, a PCB top surface 52, and a PCB bottom surface 53 opposite the PCB top surface 52 in the vertical direction Y. The PCB passageway 51, as shown in FIG. 12, is a passageway extending through the PCB top surface 52 and the PCB bottom surface 53. The PCB 50 has a pair of PCB sidewalls 57 opposite each other in the horizontal direction X.

The PCB 50, as shown in FIGS. 11-12, also comprises a power input 55 electrically connected to a PCB power initiation element 56. The power input 55, as shown in FIG. 11, is attached to the PCB 50 and receives a complementary input or connector that provides power to the PCB 50, which charges a power source 84 connected to the PCB 50 as described in detail below. The power input 55 in an exemplary embodiment is a USB C connector or a Micro USB connector. In various other embodiments, the power input 55 may be any type of connector commonly used to provide power to PCBs.

The PCB 50 has a processor and a memory with algorithms stored thereon; the processor is powered by the power input 55 and activated by the PCB power initiation element 56. The memory is a non-transitory computer readable medium. Any functions that the repellent device 1 is described as performing herein are executed by the processor according to the algorithms stored on the memory.

As shown in FIGS. 3, 9, and 12, a PCB base 54 attaches the PCB 50 to the housing 10. The PCB base 54 has a pair of PCB base sidewalls 58 opposite each other in the horizontal direction X, and a PCB base passageway 59. The PCB base passageway 59, as shown in FIG. 12, is a passageway extending through a portion of the PCB base 54 that aligns with the PCB passageway 51 when the PCB 50 is positioned in the PCB base 54. In another embodiment, the pair of PCB base sidewalls 58 may be opposite each other in any direction or located relative to each other in any way that allows the PCB base 54 to function as described herein.

As shown in FIGS. 11-12, the repellent device 1 also includes volatilization elements 60. The volatilization elements 60 comprise a heating element 61, a temperature sensor 66 positioned adjacent to the heating element 61, a thermal material 68 positioned around the temperature sensor 66, and a pocket part 69.

The heating element 61, as shown in FIGS. 11 and 12, has a heating element passageway 62 and a heating element wall 63 surrounding the heating element passageway 62. The heating element passageway 62 extends through the heating element 61 along an inner surface of the heating element wall 63. The heating element wall 63 has an exterior wall surface 64, on a side opposite the heating element passageway 62, that has a thermal material contact portion 65. The heating element 61 is a component or material that generates heat under control of the PCB 50.

As shown in FIG. 12, the temperature sensor 66 has a temperature sensing portion 67. In an exemplary embodiment, the temperature sensing portion 67 is a thermistor. In various other embodiments, the temperature sensor 66 may be any type of temperature sensor that allows the temperature sensor 66 to function as described herein.

As shown in FIG. 11, the thermal material 68 is a material that is thermally conductive. The thermal material 68 of the present embodiment is a thermal paste. In various other embodiments, the thermal material 68 may be any material, such as a paste, a gel, an adhesive, an epoxy, etc., that allows the thermal material 68 to function as described herein.

As shown in FIGS. 11-12, the pocket part 69 is a partial wall that surrounds a portion of the heating element 61 and is spaced apart from the heating element 61. The pocket part 69 has a pocket cavity 70, and a pocket part wall 71 having an interior pocket part wall surface 72. The pocket cavity 70 is formed and defined by the interior pocket part wall surface 72 and the thermal material contact portion 65 of the exterior heating element wall surface 64.

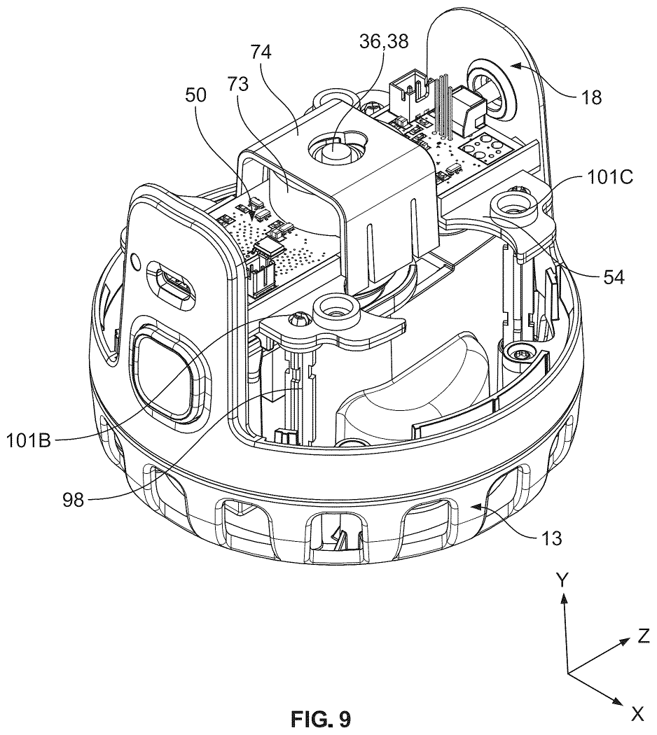

The volatilization elements 60, as shown in FIGS. 9 and 12, also comprise an insulator 73 and a heater cap 74. The insulator 73 of the present embodiment, as shown in FIGS. 3, 9, and 12, is an insulative ring. The insulator 73 may be any type of material and shape of insulator that allows the insulator 73 to function as described herein.

The heater cap 74, as shown in FIG. 12, has a pair of heater cap retaining walls 75 opposite one another in the horizontal direction X. In various other embodiments, the heater cap 74 may have any number of heater cap retaining walls 75 that may be opposite each other in any direction, or located relative to each other in any way, that allows the heater cap 74 to function as described herein. The heater cap 74 may be formed of a high temperature plastic material. In various other embodiments, the heater cap 74 may be formed of any type of material that allows the heater cap 74 to function as described herein.

As shown in FIGS. 3 and 11, the repellent device 1 also includes power components 80 connected to the PCB 50. The power components 80 comprise a lighting element 81, a light pipe 83, a power source 84, and a power cycle element 85.

The lighting element 81 of the present embodiment, as shown in FIGS. 4 and 11, is a multi-colored LED. In another embodiment, the lighting element 81 may be a single-colored LED. In various other embodiments, the lighting element 81 may be an incandescent tungsten bulb or electro-luminescence device or any lighting component(s) that allows the lighting element 81 to function as described herein.

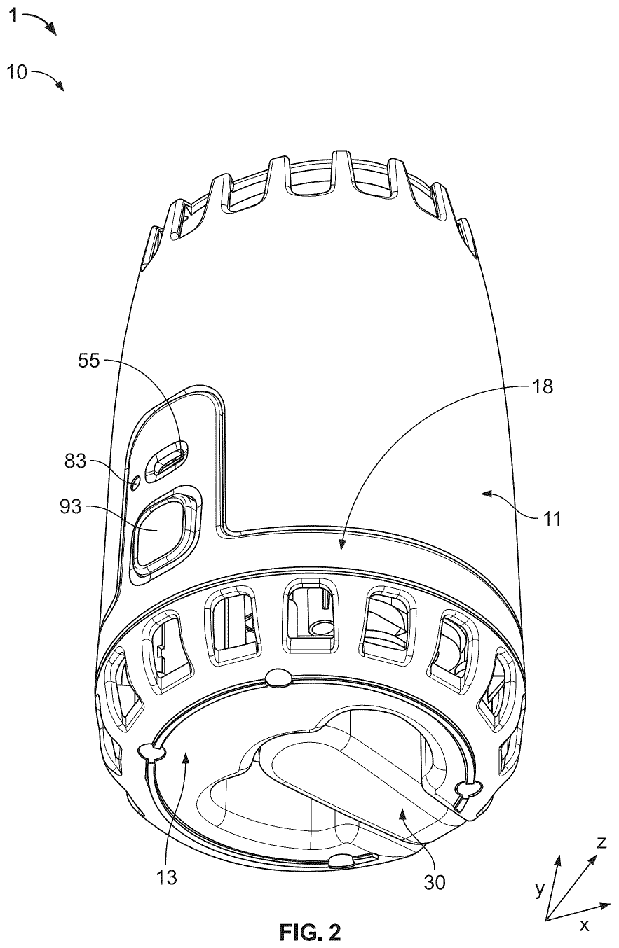

The light pipe 83, as shown in FIGS. 2-3, is made of a transparent material or a translucent material. The light pipe 83 of the present embodiment has a cylindrical shape. In various other embodiments, the light pipe 83 may have any shape that allows the light pipe 83 to function as described herein.

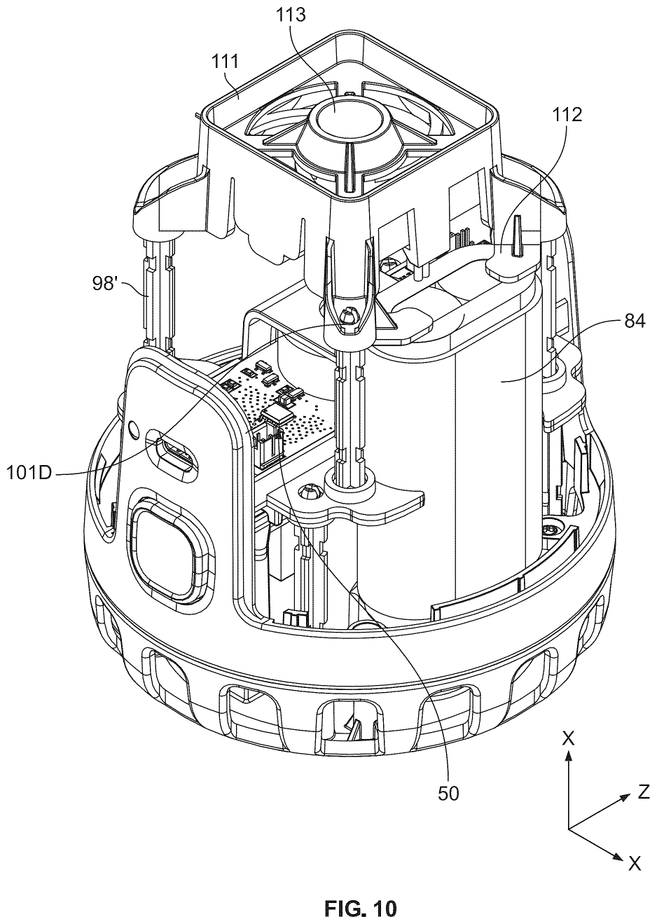

The power source 84, as shown in FIGS. 3 and 10, provides power to the repellent device 1. The power source 84 of the present embodiment is a rechargeable battery. In an exemplary embodiment, the power source 84 is a dual cell 18650 lithium battery. As shown in FIGS. 3 and 10, the power source 84 has the shape that corresponds to a portion of the PCB base 54. In various other embodiments, the repellent device 1 may be powered by other power sources, such as a connector pluggable to an outlet.

In the present embodiment, the power cycle element 85 is a power button that is mechanically actuatable and electrically connected to the PCB 50. In various other embodiments, the power cycle element 85 may be a switch or anything that allows the power cycle element 85 to function as described herein.

As shown in FIG. 3, the repellent device 1 includes a slide assembly 91. As shown in FIGS. 4, 7, and 8, the slide assembly 91 comprises a compression element 92 and a contact surface 93. The compression element 92, in the shown embodiment, is a spring. In various other embodiments, the compression element 92 may be anything that compresses when force is applied, such as rubber cushions, foam pads, etc. that allows the slide assembly 91 to function as described herein. The contact surface 93 is a surface of a slide body 96, as shown in FIGS. 2, 4, and 8, that is visible from an exterior 2 of the repellent device 1. As shown in FIG. 7, a slide assembly passageway 94 extends through the slide body 96 in the vertical direction Y. A portion of a wall of the slide body 96 adjacent to the slide assembly passageway 94 forms a retaining surface 95.

As shown in FIGS. 3 and 10, the repellent device 1 also includes a fan 110 and a fan housing 111. The fan 110 maybe be any type of fan device that fits within the housing 10 and can produce sufficient air flow under control of the PCB 50. The fan housing 111, as shown in FIG. 10, has a power source retaining portion 112 and a fan bearing surface 113. The fan housing 111 also has snap-in support attachment elements 101D. In another embodiment, the fan housing 111 is omitted and the elements of the fan housing 111 are formed directly onto/into the fan 110.

Assembly of the repellent device 1 according to FIGS. 1-12 is now described. While assembly of the repellent device 1 is described in a specific order, the assembly description is merely exemplary; the repellent device 1 may be assembled in different orders.

The bottom shell 13 is attached to the shell band 18 with a plurality of fasteners 99, shown in FIG. 3. The plurality of fasteners 99 extend through a plurality of fastener attachment elements 100 of the bottom shell 13 and a plurality of fastener attachment elements 100′ of the shell band 18 to attach the elements to each other. In the present embodiment, the plurality of fasteners 99 are screws that thread into the fastener attachment elements 100,100′. In various other embodiments, the plurality of fasteners 99 may be any type of fastener that can attach elements to each other as described herein. The bottom shell 13 is attached to the shell band 18 in the orientation shown in FIG. 7.

Once the bottom shell 13 and the shell band 18 are attached to each other, the slide assembly 91, as shown in FIGS. 7 and 8, is attached into the interior cavity of the bottom shell 13. The contact surface 93 is received through a respective shell band passageway 19 and is visible from the exterior 2 of the repellent device 1. The port passageway 16 and the slide assembly passageway 94, as shown in FIG. 7, are not fully aligned when the slide assembly 91 is attached into the interior cavity of the bottom shell 13.

In the PCB 50, as shown in FIG. 11, the power input 55, the PCB power initiation element 56, the heating element 61, the temperature sensor 66, and the lighting element 81 are all attached to the PCB 50, for example, by soldering. The lighting element 81 is attached to the PCB bottom surface 53. In various other embodiments, the lighting element 81, and any other elements attached to the PCB 50, may be attached to any surface of the PCB 50. The pocket part 69, as shown in FIG. 11, is attached into the PCB passageway 51 with, for example, a snap fit. The heating element 61 is then received in a passageway of the pocket part 69; the heating element passageway 62 is aligned with the PCB passageway 51. The pocket cavity 70 is then formed once the heating element 61 is received in the passageway of the pocket part 69. The temperature sensing portion 67 is positioned in the pocket cavity 70.

As shown in FIG. 11, the thermal material 68 is disposed in the pocket cavity 70. The thermal material 68 at least contacts the thermal material contact portion 65 of the exterior wall surface 64 of the heating element 61, the temperature sensing portion 67, and the interior pocket part wall surface 72 when received in the pocket cavity 70. When in the pocket cavity 70, the temperature sensing portion 67 is in thermal communication with the heating element 61; the thermal communication is enhanced by the thermal material 68. In another embodiment, the temperature sensing portion 67 is encapsulated by the thermal material 68 received into the pocket cavity 70.

The PCB 50 is then attached to the PCB base 54, for example, with fasteners or adhesive, with the PCB passageway 51 aligned with the PCB base passageway 59. As shown in FIG. 9, the insulator 73 is positioned around the exterior heating element wall surface 64 such that the insulator 73 surrounds the heating element 61 and insulates the heating element 61 from the exterior environment (e.g., air). The heater cap 74 is attached to the PCB 50 and the PCB base 54 such that the pair of heater cap retaining walls 75 latch to the pair of PCB sidewalls 57 and the pair of PCB base sidewalls 58 as shown in FIG. 9. The heater cap 74 retains the insulator 73 on the heating element 61 and centers the heating element 61.

All elements attached to the PCB 50 as described above are then attached to the bottom shell 13 with a first set of snap-in supports 98. As shown in FIG. 7, the first set of snap-in supports 98, and a second set of snap-in supports 98′, as shown in FIGS. 3 and 9-10, are fasteners that have portions that snap and lock in place to create attachments between elements of the repellent device 1. In the present embodiment, each snap-in support of the first set and second set of snap-in supports 98, 98′ snaps and locks into place into a plurality of snap-in support attachment elements 101A, 101B, 101C, 101D to attach elements of the repellent device 1 together. In various other embodiments, the first set and second set of snap-in supports 98,98′ may be any type of snap-in fastener or any other type of fastener. As shown in FIGS. 7 and 9, one end of the snap-in supports 98 are inserted into a plurality of snap-in support attachment elements 101A of the bottom shell 13. The other end of the first set of snap-in supports 98 are then inserted into a plurality of snap-in support attachment elements 101B of the PCB base 54.

As shown in FIG. 9, when attached to the bottom shell 13, elements of the PCB assembly align with some of the plurality of shell band passageways 19 of the shell band 18. The power input 55 and the PCB power initiation element 56 align with respective passageways of the plurality of shell band passageways 19 to be exposed to the exterior, and the lighting element 81 is received into the lighting guide 17 as shown in FIG. 4. The PCB 50 is attached in the housing 10 such that it is positioned above the cartridge 30. In another embodiment, the PCB 50 may be in any location in relation to the cartridge 30 such as below, on the side of, etc.

The light pipe 83 and the power cycle element 85 are inserted into respective shell band passageways 19, as shown in FIGS. 1-3. When the light pipe 83 is inserted into its respective shell band passageway 19 it is in communication with a PCB light on the PCB 50. When the power cycle element 85 is inserted into its respective shell band passageway 19 it is aligned with the PCB power initiation element 56.

As shown in FIGS. 9 and 10, one end of the second set of the snap-in supports 98′ are then inserted into the snap-in support attachment elements 101C of the PCB base 54. The power source 84 is then attached to the housing 10 as shown in FIG. 10. The power source 84 is disposed in the portion of the PCB base 54 that is shaped to correspond to the shape of the power source 84. Electrical connections between the power source 84 and the PCB 50 may be made before or after the power source 84 is attached to the housing 10.

The fan 110, via the fan housing 111, is attached to the repellent device 1 above the PCB 50 as shown in FIG. 10. In another embodiment, the fan 110 may be anywhere relative to the housing 10 or the PCB 50 that allows the fan 110 to function as described herein. As shown in FIG. 10, the fan 110 is inserted into and attached to the fan housing 111. The other end of the second set of the snap-in supports 98′ are then inserted into the set of snap-in support attachment elements 101D of the fan housing 111. When attached to the repellent device 1, as shown in FIG. 10, the power source retaining portion 112 of the fan housing 111 abuts a top of the power source 84 to retain the power source 84 in place in the housing 10.

The top shell 11 is then attached to the shell band 18. As shown in FIG. 3, the top shell 11 and the shell band 18 each have interconnection portions 23. The interconnection portions 23 of the top shell 11 and the shell band 18 are shaped to correspond to each other. The respective interconnection portions 23 of the top shell 11 and the shell band 18 attach to one another, for example, with a snap fit thereby creating an interconnection joint 24 as shown in FIG. 1. In various other embodiments, the top shell 11 and the shell band 18 may not have the interconnection portions 23 and instead may be attached to one another using any type of attachment method (e.g., fasteners, adhesives, soldering, welding, plastic welding, etc.).

As shown in FIG. 4, the fan retaining portion 25 is shaped complementary to the fan bearing surface 113. When the top shell 11 and the shell band 18 are attached to each other, the fan retaining portion 25 abuts the fan bearing surface 113, retaining the fan housing 111 in place in the housing 10. In the embodiment where the fan 110 is in another part of the housing 10, the fan retaining portion 25 may not be in the top shell 11 and may instead be in another part of the housing 10 to retain the fan 110 in that part of the housing 10.

To assemble the cartridge 30, the first cartridge part 39 and the second cartridge part 40, shown in FIG. 6, are ultrasonically welded together to form the cartridge 30 shown in FIG. 5. In various other embodiments, the first cartridge part 39 and the second cartridge part 40 may be attached together in any way (e.g., adhesives, other methods of plastic welding, etc.) that allows the cartridge 30 to function as described herein. In another embodiment, the cartridge 30 does not have the first cartridge part 39 and the second cartridge part 40, and is instead monolithically formed in a single piece.

The wick 36 and the bushing 41 are inserted into the cartridge passageway 42 as shown in FIG. 5. The first wick portion 37 and a portion of the bushing 41 are inserted into the cartridge passageway 42 such that the first wick portion 37 and the portion of the bushing 41 seal the cartridge interior 31. The seal prevents the repellent mixture 3 contained in the cartridge interior 31 from exiting the cartridge interior 31 from anywhere but through the second wick portion 38.

The first wick portion 37, as shown in FIG. 5, extends through the top cartridge wall 33, the cartridge passageway 42, and the bushing passageway into the cartridge interior 31. The second wick portion 38 extends away from the top cartridge wall 33 and the bushing 41. The repellent mixture 3 is transported through the wick 36 such that it flows through the first wick portion 37 into the second wick portion 38 and out of the cartridge 30.

The cartridge 30 is removably insertable into the port passageway 16 in the vertical direction Y. The slide assembly 91 begins in the position shown in FIG. 7. A user depresses the contact surface 93 to push the slide body 96 into the housing 10, against the force of the compression element 92. The slide body 96 is pushed into the housing 10 until the slide assembly passageway 94 is fully aligned with the port passageway 16 in the vertical direction Y. In this position of the slide body 96, the cartridge 30 is inserted into the port passageway 16 until the cartridge 30 abuts the bottom shell 13 and the neck portion 45 is in the position shown in FIG. 8. In this position, the pressure on the contact surface 93 is released and the compression element 92 returns the slide body 96 to a latched position L shown in FIG. 8; the compression element 92 biases the slide body 96 toward the latched position L. The neck portion 45, in the latched position L, is latched onto the slide assembly 91 by engagement with the retaining surface 95, retaining the cartridge 30 in the housing 10. The cartridge 30 is releasable from the latched position L, as described in further detail below, by depressing the contact surface 93 and moving the cartridge 30 counter to the vertical direction Y.

When the cartridge 30 is removably inserted into the port passageway 16 and the port 15, as shown in FIG. 1, the front cartridge wall 32 is visible from the exterior 2 of the repellent device 1 at the port 15. The cartridge 30 and the lighting element 81 are adjacent to each other as shown in FIG. 4, and the wick 36 is in a horizontal center HC of the housing 10. The second wick portion 38 extends into and passes through the PCB passageway 51 and the PCB base passageway 59, and is positioned in the heating element passageway 62 and the passageway of the pocket part 69.

Operational aspects of the embodiment of the repellent device 1 according to FIGS. 1-12 are now described.

The repellent device 1 is initiated by the power cycle element 85 and the PCB power initiation element 56. When the power cycle element 85 is displaced toward the PCB power initiation element 56, the power cycle element 85 activates the PCB power initiation element 56 by, for example, contacting a button on the PCB power initiation element 56.

Once assembled and loaded with the cartridge 30 containing the repellent mixture 3, statuses of the repellent device 1, when the repellent device 1 is on and operating, are indicated by the lighting element 81 and the PCB light. The lighting element 81 facing the cartridge 30 as shown in FIG. 4 illuminates the cartridge interior 31, through the transparent or translucent walls 32, 33 of the cartridge 30, to indicate a plurality of statuses of the repellent device 1 in a plurality of same or different colors. For example, when the repellent device 1 is turned on and operating, the lighting element 81 may illuminate the cartridge interior 31 in a first color. In a further example, when the power source 84 is running low on power, and the repellent device 1 is on and operating, the lighting element 81 may illuminate the cartridge interior 31 in a second color. In the embodiment where the LED is a single-colored LED, the on and operating status of the repellent device 1 may be indicated by a brightness or blinking of the LED. For example, in the single-colored LED embodiment, a solid bright light when the repellent device 1 is on and operating may be an indication that the power source 84 has sufficient battery, and a low brightness blinking light may indicate that the power source 84 is low on battery.

The PCB light illuminates through the light pipe 83 such that it is visible from the exterior 2 of the repellent device 1. In an embodiment, the PCB light is a first color when the power source 84 is not fully charged and is being charged by the connector, and is a second color when the power source 84 is fully charged and the connector is still connected to the power input 55. In another embodiment, the PCB light is a first blinking color when the connector is charging the power source 84 to indicate that the power source 84 is not fully charged and the PCB light is a solid same first color when the power source 84 is fully charged and the connector is still attached, or vice versa.

When the repellent device 1 is on and operating, the repellent device 1 volatizes, atomizes, and disperses the repellent mixture 3. The repellent mixture 3 is transported from the cartridge interior 31 through the first wick portion 37 and into the second wick portion 38. Once in the second wick portion 38, the heating element 61 heats the repellent mixture 3 flowing through the second wick portion 38 until it is volatilized. While the heating element 61 volatizes the repellent mixture 3, the temperature sensing portion 67 measures a temperature of the heating element 61 to ensure the temperature of the heating element 61 is consistent. If the temperature of the heating element 61 is low or high, it is corrected back to a proper operating temperature to ensure consistency. The thermal material 68 improves the heat transfer between the heating element 61 and the temperature sensing portion 67 to ensure that the heating element 61 is being properly controlled and heating to the correct temperature.

After the repellent mixture 3 is volatilized by the heating element 61, it is atomized and dispersed by the fan 110. The fan 110 pulls air into the housing 10 through the first set of vents 21. The air then mixes with the volatilized repellent mixture 3. The air mixed with the volatilized repellent mixture 3 is then further pulled through the housing 10 until reaching the fan 110. When at the fan 110, the fan 110 atomizes and disperses the air mixed with the volatilized repellent mixture 3 through the second set of vents 22. In an exemplary embodiment, the fan 110 atomizes and disperses the volatilized repellent mixture 3 before it can form as condensation on any surface of the repellent device 1.

A user can examine a level of the repellent mixture 3 at the front cartridge wall 32 that is exposed at the port 15, as shown in FIG. 1. The illumination of the cartridge 30 by the lighting element 81 facing the cartridge 30, through the transparent or translucent walls 32, 33, improves the ability of the user to examine the remaining level of the repellent mixture 3 from an exterior of the repellent device 1. The user can compare the level of the repellent mixture 3 to the graduation marks 35 without removing the cartridge 30 to determine when the cartridge 30 needs to be replaced or refilled.

When the cartridge 30 needs to be replaced, or refilled with more of the repellent mixture 3, it is detachable from the repellent device 1 in the released position R, as shown in FIG. 7. The slide assembly 91 is placed in the released position R when a force applied to the contact surface 93 displaces the slide body 96 forward in the horizontal direction X as indicated by the dotted arrow indicated by R in FIG. 7. When the slide body 96 is displaced along the horizontal direction X, the compression element 92 is compressed and the slide assembly passageway 94 aligns with the port passageway 16 thereby releasing the neck portion 45 of the cartridge 30 from the retaining surface 95. When the neck portion 45 is released from the retaining surface 95, the cartridge 30 is free to slide through the port passageway 16 until it is detached from the housing 10. After the neck portion 45 passes through the slide assembly passageway 94, the compression element 92 uncompresses, thereby resetting the slide assembly 91 back to its original position shown in FIG. 7.

The repellent device 1, as shown in FIGS. 1-12, allows for easier removable insertion of the cartridge 30, as compared to typical repellent devices that require disassembly of their housing to access their cartridge. Additionally, gauging the level of the repellent mixture 3 in the cartridge 30 is easier for a user than typical repellent devices, as the cartridge 30 is visible from the exterior 2 of the repellent device 1. Further, the lighting element 81 better portrays statuses of the repellent device 1 than other typical repellent devices, as the lighting element 81 illuminates the cartridge interior 31, acting like a light-pipe lens which in turn makes the cartridge interior 31 and the repellent mixture 3 therein more visible, especially in bright environments. Moreover, the volatilized repellent mixture 3 does not condensate on surfaces of the repellent device 1 due to the fan atomizing and dispersing the repellent mixture 3 once it is volatilized by the heating element 61, which prolongs the life of the repellent device 1 and disperses the repellent mixture 3 over a wider effective area. The repellent device 1 also has better and more repeatable thermal connections and consistent performance than typical repellent devices due to the use of the thermal material 68.

1. A repellent device, comprising:
a housing having a port;
a cartridge having a shape corresponding to the port and containing a repellent material, the cartridge is removably insertable into the housing and has a front cartridge wall visible at the port from an exterior of the repellent device when the cartridge is disposed in the housing;
a PCB disposed in the housing;
a heating element attached to the PCB; and
a fan positioned on a side of the PCB opposite the cartridge, the cartridge contains a repellent mixture volatized by the heating element, the volatilized repellent mixture is atomized and dispersed by the fan.

2. The repellent device of claim 1, further comprising a slide assembly disposed in the housing, the cartridge is releasably latched in the housing by the slide assembly when the cartridge is positioned in the port.

3. The repellent device of claim 2, wherein the cartridge is removable from the port by displacing the slide assembly from a latched position to a released position, the slide assembly is biased into the latched position by a compression element.

4. The repellent device of claim 3, wherein the slide assembly has a slide body with a slide assembly passageway extending through the slide body, the cartridge is inserted through the slide assembly passageway in the released position and a retaining surface of the slide body adjacent to the slide assembly passageway engages the cartridge in the latched position.

5. The repellent device of claim 1, wherein the cartridge has at least one graduation mark on the front cartridge wall, the at least one graduation mark indicates a level of a repellent mixture contained in a cartridge interior of the cartridge.

6. The repellent device of claim 1, further comprising-a a lighting element attached to the PCB, the PCB is positioned above the cartridge and the lighting element is disposed on a side of the PCB facing the cartridge.

7. The repellent device of claim 6, wherein the lighting element is received in a lighting guide of the housing, the lighting guide is between the cartridge and the PCB.

8. The repellent device of claim 6, wherein the cartridge has a wall that is transparent or translucent, the lighting element illuminates a cartridge interior of the cartridge through the wall.

9. The repellent device of claim 8, wherein the lighting element indicates a plurality of statuses of the repellent device.

10. The repellent device of claim 6, wherein the cartridge has a cartridge interior and a wick, the wick has a first wick portion in the cartridge interior and a second wick portion extending from the first wick portion away from the cartridge.

11. The repellent device of claim 10, wherein the second wick portion extends through a PCB passageway of the PCB when the cartridge is disposed in the housing.

12. The repellent device of claim 11, wherein the heating element has a heating element passageway, the heating element passageway is aligned with the PCB passageway, the second wick portion extends into the heating element passageway.

13. (canceled)

14. The repellent device of claim 12, wherein the repellent mixture flows through the first wick portion into the second wick portion, the heating element volatizes the repellent mixture flowing through the second wick portion.

15-23. (canceled)

24. The repellent device of claim 1, wherein the fan is aligned with the cartridge.

25. The repellent device of claim 1, wherein the atomized volatilized repellent mixture is dispersed by the fan through a top part of the housing, the top part of the housing is opposite the cartridge.

26. The repellent device of claim 25, wherein a fan retaining portion connected to the top part protrudes into an interior of the housing, the fan retaining portion abuts the fan and retains the fan within the housing.

27. A repellent device, comprising:
a housing having a port;
a cartridge having a shape corresponding to the port and containing a repellent material, the cartridge is removably insertable into the housing and has a front cartridge wall visible at the port from an exterior of the repellent device when the cartridge is disposed in the housing; and
a slide assembly disposed in the housing, the cartridge is releasably latched in the housing by the slide assembly when the cartridge is positioned in the port, the slide assembly has a slide body with a slide assembly passageway extending through the slide body.

28. The repellent device of claim 27, wherein the cartridge is removable from the port by displacing the slide assembly from a latched position to a released position, the slide assembly is biased into the latched position by a compression element.

29. The repellent device of claim 28, wherein the cartridge is inserted through the slide assembly passageway in the released position and a retaining surface of the slide body adjacent to the slide assembly passageway engages the cartridge in the latched position.

30. A repellent device, comprising:
a housing having a port;
a cartridge having a shape corresponding to the port and containing a repellent material, the cartridge is removably insertable into the housing and has a front cartridge wall visible at the port from an exterior of the repellent device when the cartridge is disposed in the housing;
a PCB positioned above the cartridge; and
a lighting element attached to the PCB, the lighting element is aligned with the cartridge.

31. The repellent device of claim 30, wherein the lighting element is disposed on a side of the PCB facing the cartridge.

32. The repellent device of claim 31, wherein the lighting element is received in a lighting guide of the housing, the lighting guide is between the cartridge and the PCB.

33. The repellent device of claim 31, wherein the cartridge has a wall that is transparent or translucent, the lighting element illuminates a cartridge interior of the cartridge through the wall.
